(19) United States
(12) Patent Application Publication
(10) Pub. No.: US 2024/0339941 A1
(43) Pub. Date: Oct. 10, 2024

(54) THREE-LEVEL CONTROL CIRCUIT, POWER CONVERSION DEVICE, AND CONTROL METHOD THEREOF

(71) Applicant: Ace Power and Technology Co., Ltd, Shanghai (CN)

(72) Inventor: Yuetian Wang, Shanghai (CN)

(21) Appl. No.: 18/579,327

(22) PCT Filed: Sep. 1, 2022
(86) PCT No.: PCT/CN2022/116512

§ 371 Date: Jan. 12, 2024

(30) Foreign Application Priority Data
Dec. 3, 2021 (CN) 202111470156.2

(51) Int. Cl. H02M 7/797; H02M 1/00; H02M 1/14; H02M 1/42

(52) U.S. Cl. CPC H02M 7/797; H02M 1/0043; H02M 1/14; H02M 1/4216

(57) ABSTRACT

The present application provides a three-level control circuit, a power conversion device and a control method thereof. The three-level control circuit includes two first main lines and two second main lines between a three-phase port and a two-phase terminal thereof. The first main line includes a plurality of first conversion branches, the second main line includes two capacitor branches and a plurality of second conversion branches, and the first conversion branches and the second conversion branches are in interleaved connection by an inverter interleaving technology. Each of the capacitor branches has a third capacitor and a fourth capacitor connected in series. The plurality of the first conversion branches of each of the first main lines are respectively connected to correspond to the capacitor branch, and a connection point is located between the third capacitor and the fourth capacitor.

### TECHNICAL FIELD

The present application relates to the field of automotive batteries, in particular to a three-level control circuit, a power conversion device and a control method thereof.

### BACKGROUND

With the popularization of new energy vehicles, the demand for domestic DC charging posts is increasing, and the demand for the power of the charging posts is increasing. The trend of use of automobile-equipped batteries as residential power sources is accelerating, therefore, more and more researches have been done on bidirectional converters. By using the device, an electric automobile can not only be used as an emergency power source, but also contribute to saving electricity charges if it is well used. The electric automobile can be charged when electricity from the grid is cheap, and can be used as an emergency power supply for household appliances when power is cut off due to disasters and other reasons, and meanwhile can be connected to the grid for power generation during the period when the price of electricity is high. Therefore, the higher the efficiency of the converter is, the cheaper the price of the converter is, the more benefits the user will get, the better the quality of the grid-connected current and the emergency power supply is, and the less the pollution to the grid and the damage to the electric equipment is.

As can be seen from the power module shown in FIG. 1, which is commonly used in the market, the power module is applied to a high-current bidirectional converter, and the power increase is achieved by packaging a larger device. Although this scheme is simple and easy to control, the cost of the module is high, and the larger the power is, the larger the ripple current is, and the larger the filter volume is.

### SUMMARY

In order to overcome at least one defect of a household charging module in the prior art, the invention provides a power conversion circuit which can overcome the problems of high power promotion and conversion efficiency and has low cost. The application provides a three-level control circuit, a power conversion device and a control method thereof, wherein the three-level control circuit includes two first main lines and two second main lines between a three-phase port and a two-phase terminal thereof.

The first main line includes a plurality of first conversion branches, the second main line includes two capacitor branches and a plurality of second conversion branches, and the first conversion branches and the second conversion branches are in interleaved connection by an inverter interleaving technology. Each of the capacitor branches has a third capacitor and a fourth capacitor connected in series. The plurality of the first conversion branches of each of the first main lines are respectively connected to correspond to the capacitor branch, and a connection point is located between the third capacitor and the fourth capacitor.

In an embodiment of the present application, the three-level control circuit further comprise a capacitor circuit, wherein the capacitor circuit comprises a first capacitor and a second capacitor; the three-phase port includes a first alternating current (AC) port, a second AC port, and a third AC port; the two-phase terminal includes a first direct current (DC) terminal and a second DC terminal; the first capacitor and the second capacitor are coupled between the first AC port and the third AC port, and there is an intermediate node between the first capacitor and the second capacitor, the second AC port is connected respectively to the capacitor branches through the intermediate node, and the connection point is located between the third capacitor and the fourth capacitor of each of the capacitor branches.

In an embodiment of the application, one end of the plurality of the first conversion branches is connected in parallel into the first main line through an inductive coil; the plurality of the second conversion branches and the capacitor branch are connected in parallel between the first DC terminal and the second DC terminal; wherein the first conversion branch and the second conversion branch correspond to each other one by one.

In an embodiment of the present application, the three-level control circuit is a T-type three-level control circuit or a PFC three-level control circuit or an I-type three-level control circuit.

In an embodiment of the present application, when the three-level control circuit is a T-type three-level control circuit, at least two controllable semiconductor devices are connected in series on each of the first conversion branches, at least two controllable semiconductor devices are connected in series on each of the second conversion branches; the first conversion branches and the second conversion branches correspond to each other one by one and intersect to form an intersection node, and the intersection node is located between the controllable semiconductor devices connected in series on the second conversion branch.

In an embodiment of the present application, there is also provided a power conversion device comprising the three-level control circuit and the control module described above. One end of the control module is connected to the respective first conversion branch of each of the two first main lines, and the connection point is located between the first main line and the first conversion branch; and the other end of the control module is connected to the first capacitor, the second capacitor, the third capacitor, and the fourth capacitor.

In an embodiment of the present application, there is further provided a control method applied to the above power conversion device, in which the control module provides a same current reference value for the plurality of the first conversion branches of each of the first main lines according to a voltage loop output, and equalizes the currents of the first conversion branches through closed-loop regulation.

In an embodiment of the present application, the voltage loop of the power conversion device is a DC side voltage during the charging process, and the voltage loop is an AC side voltage during the discharging process; wherein the DC side voltage is equal to a sum of that of the third capacitor and the fourth capacitor; the AC side voltage is equal to a sum of that of the first capacitor and the second capacitor.

In an embodiment of the present application, the degree difference between the inverter of each of the first conversion branch and the second conversion branch is 360/N in a high-frequency operating state, where N is the number of the first conversion branches on the first main line.

In an embodiment of the present application, in the low-frequency operating state, the driving level of the inverters of each of the second conversion branches are the same.

With the three-level control circuit, the power conversion device and the control method thereof provided by the application, the switching loss of the switching device is reduced, the conversion efficiency is higher, and the application of multi-channel inverter interleaving technology also reduces the ripple and the volume of the filter device, and effectively reduces the practical application cost.

In order to make the above and other objects, features, and advantages of the present application be more obvious and easier to understand, hereinafter detailed description is given by combining preferred embodiments in conjunction with the accompanying drawings.

### BRIEF DESCRIPTION OF DRAWINGS

To illustrate more clearly the embodiments of the present application or the technical schemes of the prior art, a brief description of the accompanying drawings in the embodiments or the prior art will be given below. Obviously, the accompanying drawings described below are only some embodiments described in this application. For those of ordinary skill in the art, other drawings can also be obtained without any creative labor from these drawings.

FIG. 1 is a schematic diagram of a topology structure of a three-level control circuit in the prior art;

FIG. 2 is a schematic diagram of a topology structure of an insulated gate bipolar transistor in the prior art;

FIG. 3 is a schematic diagram of a topology structure of a three-level control circuit according to an embodiment of the present application;

FIG. 4A is a schematic diagram of a topology structure of a PFC three-level control circuit in the prior art;

FIG. 4B is a schematic diagram of a topology structure of a PFC three-level control circuit according to an embodiment of the present application;

FIG. 4C is a schematic diagram of a topology structure of an I-type three-level control circuit according to an embodiment of the present application;

FIG. 5 is a schematic diagram of a connection structure of a control module and a three-level control circuit according to an embodiment of the present application;

FIG. 6 is a schematic diagram of a control principle of a control module according to an embodiment of the present application;

FIG. 7 is a schematic diagram of control logic of a control method according to an embodiment of the present application.

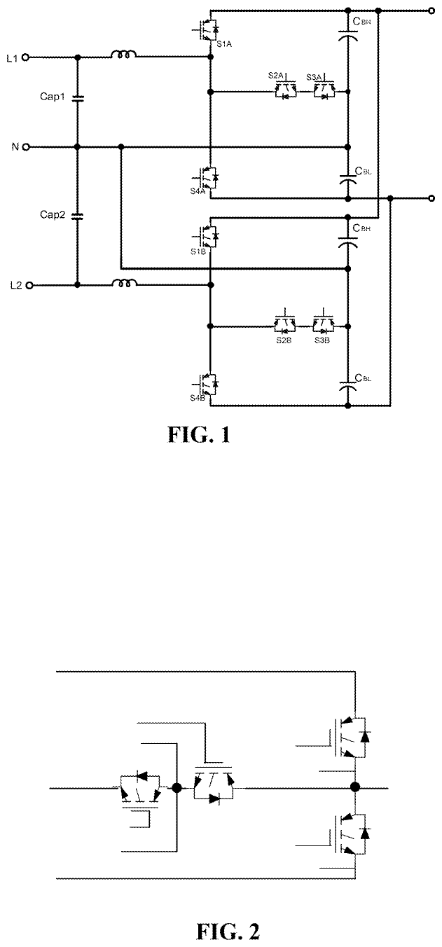

### DESCRIPTION OF EMBODIMENTS

Hereinafter the technical solution in the embodiments of the present application will be described clearly and integrally in combination with the accompanying drawings in the embodiments of the present application, and obviously the described embodiments are merely part of the embodiments, not all of the embodiments. Any other embodiment obtained by those skilled in the art based on the embodiments of the present application without paying any creative labor fall within the protection scope of the present application.

With reference to the Description and drawings below, a specific embodiment of the present application is disclosed in detail, which specifies the manner in which the principle of the present application can be adopted. It should be understood that, the scope of the embodiment of the present application is not limited. Within the scope of the spirit and clause of the appended claims, the embodiment of the present application includes many variations, modifications and equivalents.

The features described and/or shown for one embodiment can be used in one or more other embodiments in the same or similar manner, can be combined with the features in other embodiments or replace the features in other embodiments.

It should be emphasized that, the term “include/contain” refers to, when being used in the text, existence of features, parts, steps or assemblies, without exclusion of existence or attachment of one or more other features, parts, steps or assemblies.

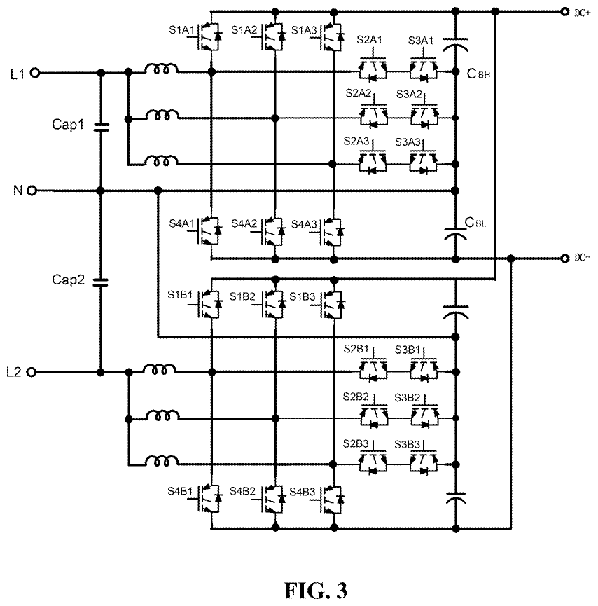

Nowadays, most domestic power supplies in some countries are low-voltage single-phase power, and for this reason, for bidirectional applications, the grid side structure is mostly two-phase three-line system, i.e. three lines of L1, L2, and N. In this structure, during charging and grid connection, the N line has no current, and L1 and L2 take over all currents; when off-grid, in order to provide single-phase power for electrical equipment, N may output voltage independently, and the specific topology structure may be as shown in FIG. 2. In the topology structure, due to the large volume of the filter, it is difficult to reduce the inductance in high-power applications, and the introduction of the wide band-gap device will lead to the problem of increasing the cost of the converter.

In view of this, the present application provides a three-level control circuit, wherein the three-level control circuit includes two first main lines and two second main lines between a three-phase port and a two-phase terminal thereof. The first main line includes a plurality of first conversion branches, the second main line includes two capacitor branches and a plurality of second conversion branches, and the first conversion branches and the second conversion branches are in interleaved connection by an inverter interleaving technology. Each of the capacitor branches has a third capacitor and a fourth capacitor connected in series. The plurality of the first conversion branches of each of the first main lines are respectively connected to correspond to the capacitor branch, and a connection point is located between the third capacitor and the fourth capacitor.

In this way, the number of the inverters is increased by using three-channel three-level interleaved parallel connection mode, and the switching loss of the switching device is effectively reduced, the conversion efficiency is higher; and meanwhile the ripple of the filter device is reduced, so that the volume of the filter can be adaptively reduced.

Further, the three-level control circuit further comprise a capacitor circuit, wherein the capacitor circuit comprises a first capacitor and a second capacitor; the three-phase port includes a first AC port, a second AC port, and a third AC port; the two-phase terminal includes a first DC terminal and a second DC terminal; the first capacitor and the second capacitor are coupled between the first AC port and the third AC port, and there is an intermediate node between the first capacitor and the second capacitor, the second AC port is connected respectively to the capacitor branches through the intermediate node, and the connection point is located between the third capacitor and the fourth capacitor of each of the capacitor branches. Further, in an embodiment of the application, the specific mode of interleaving connection by the inverter interleaving technology described above is as follows: one end of the plurality of the first conversion branches is connected in parallel into the first main line through an inductive coil; the plurality of the second conversion branches and the capacitor branch are connected in parallel between the first DC terminal and the second DC terminal; wherein the first conversion branch and the second conversion branch correspond to each other one by one. The specific structure will be described in detail in the following embodiments, and will not be described in detail here. In actual work, the three-level control circuit may be a T-type three-level control circuit or a PFC three-level control circuit or an I-type three-level control circuit, or the like. Therefore, the application based on three-level control circuit can reduce the switching loss of the switching device, and the conversion efficiency is high.

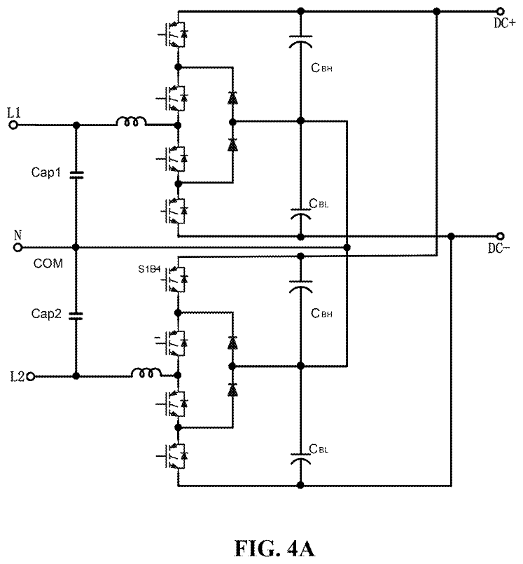

Referring to FIG. 3, in an embodiment of the present application, when the three-level control circuit is a T-type three-level control circuit, at least two controllable semiconductor devices are connected in series on each of the first conversion branches, at least two controllable semiconductor devices are connected in series on each of the second conversion branches; the first conversion branches and the second conversion branches correspond to each other one by one and intersect to form an intersection node, and the intersection node is located between the controllable semiconductor devices connected in series on the second conversion branch. Further, inductors are connected in series between the first conversion branch and the first main line.

Specifically, in order to more clearly explain the connection structure of the three-level control circuit when the inverter interleaving technology is applied, referring to FIG. 2 and FIG. 3, the structure of interleaving connection by the inverter interleaving technology is illustrated by taking the T-type three-level control circuit as an example.

As shown in FIG. 3, the first AC port, the second AC port and the third AC port are L1, N and L2 in the three-phase port, the first capacitor and the second capacitor are Cap1 and Cap2 respectively, and the third capacitor and the fourth capacitor are CBH and CBL respectively; the two first main lines and the two second main lines are coupled between the three-phase ports L1, N, L2 and the two-phase terminals DC+, DC−; wherein one first main line is led out from L1, followed by three parallel first conversion branches after the capacitor circuit and its intersection point, respectively (i.e., three conversion branches S2A1 and S3A1, S2A2 and S3A2, and S2A3 and S3A3 connected in series with the three inductive coils, respectively), all the three first conversion branches are connected to the capacitor branch connected with CBH and CBL in series; the other first main line is led out from L2 is similar to the above-described structure; wherein one second main line is led out from the two-phase terminal DC+ respectively, followed by the capacitive branch and three second conversion branches that are connected in parallel (i.e., three conversion branches S1A3 and S4A3, S1A2 and S4A2, and S1A1 and S4A1 connected in series with the three inductive coils, respectively), similarly, the other second main line led out from the two-phase terminal DC− is similar in structure to the second main line led out from DC+; the outgoing line of the second AC port N passes through the intermediate node between the first capacitor Cap1 and the second capacitor Cap2, and then is connected to the capacitor branches on the two second main lines respectively. Thus, by comparing the three-level circuit in FIG. 3 with that in FIG. 2, it can be seen that the multi-channel interleaving technology cited in the present application is that: the first main line led out from the first AC port L1 and the third AC port L2 leads out three first conversion branches respectively through three inductive coils after the first capacitor Cap1 and the second capacitor Cap2 intersect with the first main line, and the inverters S2A1, S2A2, S2A3, S3A1, S3A2, S3A3, S2B1, S2B2, S2B3, S3B1, S3B2, S3B3 are respectively connected in series in the first conversion branches, and then extended into the capacitor branch constructed by the third capacitor Cap1 and the fourth capacitor Cap2; the second main line led out from the first DC terminal DC+ and the second DC terminal DC-leads after the capacitive branch to three second conversion branches, respectively, and the inverters S1A1, S1A2, S1A3, S4A1, S4A2, S4A3, S1B1, S1B2, S1B3, S4B1, S4B2, and S4B3 are connected in series to the second conversion branches, respectively; wherein the intersection node of the first and second conversion branches of the series-connected inverters S2A1 and S3A1 is located between the second conversion branches S1A1 and S4A1, the intersection node of the first and second conversion branches of the series-connected inverters S2A2 and S3A2 is located between the second conversion branches S1A2 and S4A2, the intersection node of the first and second conversion branches of the series-connected inverters S2A3 and S3A3 is located between the second conversion branches S1A3 and S4A3, thus, each of the first conversion branches and each of the second conversion branches are connected in one-to-one correspondence to complete the intersection to form an inverter interleaving structure.

In an overall principle, the interleaving structure formed by the first and second conversion branches can be equivalent to a conversion module. For example, the above three-level control circuit may include a first capacitor circuit (Cap1 and Cap2), two capacitor bypasses (CBH and CBL), a first level circuit, and a second level circuit (two first main lines led out from L1 and L2, respectively). The first level circuit includes a plurality of first conversion modules (i.e., an interleaving structure formed by the first and second conversion branches). Each of the first conversion modules includes four ports, i.e., a first port, a second port, a third port, and a fourth port. The plurality of first conversion modules are interleaved and connected in parallel, and the first ports of all the first conversion modules are connected to the first AC port L1. The second port of each first conversion module is connected to a first DC port DC+, the third port of each first conversion module is connected to a second DC port DC−, and the fourth port of each first conversion module is connected between the third capacitor CBH and the fourth capacitor CBL in the first capacitor bypass.

Similarly, the second level circuit includes a plurality of second conversion modules, and each of the second conversion modules includes four ports, i.e., a first port, a second port, a third port, and a fourth port. The plurality of second conversion modules are interleaved and connected in parallel. The first port of each second conversion module is connected to the third AC port L2, the second port of each second conversion module is connected to the first DC port DC+, the third port of each second conversion module is connected to the second DC port DC−, the fourth port of each second conversion module is connected between the third capacitor CBH and the fourth capacitor CBL in the first capacitor bypass. The first capacitive circuit (Cap1 and Cap2) is coupled between the first AC port L1 and the third AC port L2, and two capacitive bypasses (CBH and CBL) are coupled between the first DC port DC+ and the second DC port DC−, respectively.

In an embodiment of the present application, the three-level control circuit may also be a PFC three-level control circuit or an I-type three-level control circuit or the like. When the three-level control circuit is a PFC three-level control circuit or an I-type three-level control circuit or the like, the first AC port, the second AC port, and the third AC port are also reserved as L1, N, and L2 of the three-phase ports. The first capacitor and the second capacitor are Cap1 and Cap2, respectively, the third capacitor and the fourth capacitor are CBH and CBL, respectively, and for the connection relationship between the first capacitor, the second capacitor, the third capacitor and the fourth capacitor, the main line in which the inverters are connected in series or in parallel can be divided into several conversion branches to be interleaved and connected in parallel.

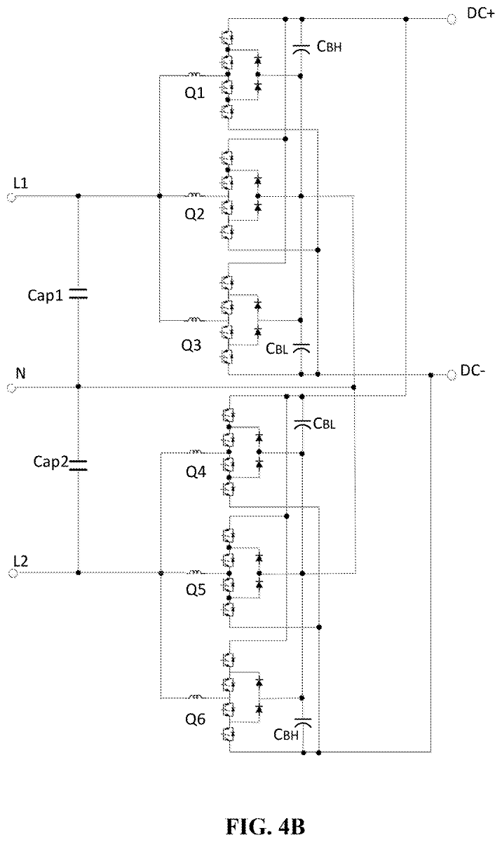

In order to facilitate that description of the connection mode and the principle thereof, reference can be made to the foregoing embodiment, when the three-level control circuit is a T-type three-level control circuit, each first conversion module includes an inductor and four inverters, i.e., the first inductor, the first inverter, the second inverter, the third inverter, and the fourth inverter. The first port of the first inductor is the first port of the first conversion module, and the second port of the first inductor is connected respectively to the first port of the first inverter, the first port of the second inverter, and the first port of the third inverter. The second port of the first inverter is the second port of the first conversion module. The second port of the second inverter is the third port of the first conversion module. The second port of the third inverter is connected to the first port of the fourth inverter. The second port of the fourth inverter is the fourth port of the first conversion module. Each second conversion module includes an inductor and four inverters, and the connection structure of the internal components of each second conversion module is the same as that of the first conversion module. When the three-level control circuit is a PFC three-level control circuit, each first conversion module includes an inductor, four inverters and two diodes, i.e., a first inductor, a first inverter, a second inverter, a third inverter, a fourth inverter, a first diode and a second diode, and each second conversion module includes an inductor, four inverters and two diodes. Specifically referring to FIGS. 4A and 4B, Q1 to Q3 are the plurality of first conversion modules included in the first level circuit; Q4 to Q6 are the plurality of second conversion modules included in the second level circuit. The connection relationship between the first conversion modules and the second conversion modules may be the same as that of the connection principle of FIG. 3, so as to realize the multi-channel interleaving and parallel connection.

In an embodiment of the present application, when the three-level control circuit is an I-type three-level control circuit, each first conversion module includes an inductor and six inverters, i.e., the first inductor, the first inverter, the second inverter, the third inverter, the fourth inverter, the fifth inverter, and the sixth inverter, and each of the second conversion modules includes an inductor and six inverters. Specifically referring to FIG. 4C, the difference between the I-type three-level control circuit and the PFC three-level control circuit is that the diodes are replaced with corresponding inverters, and the overall connection structure is similar to that of FIG. 4B, which will not be described in detail herein.

Thus, the three-level control circuit provided by the present application can utilize the reduced ripple characteristic of the filter device caused by the interleaved parallel connection while maintaining the advantages of the three-level control circuit, the volume of the filter can be adaptively reduced, so that the hardware cost can be reduced while the switching loss of the switching device can be reduced and the conversion efficiency can be improved.

In view of the differences in household electricity supply in some regions or countries, for bi-directional applications, the second AC port in the network side structure may not be available. To this end, in an embodiment of the present application, a controllable switch is connected in series between the second AC port and the intermediate node. When the controllable switch is closed, the three-level control circuit provided by the present application can output two mutually independent loads in an inversion mode, so as to meet the requirements of low-voltage power grids in such regions or countries. Therefore, based on the above structure, whether or not to close the controllable switch can be determined according to the actual situation of the household power supply or the power supply mode of the region where the controllable switch is located, and the control mode of the controllable switch can be realized by using the prior art, which will not be described in detail here.

In an embodiment of the present application, there is provided a control method applied to the above power conversion device, through which the currents of the first conversion branches are equalizes by a control module which is connected to the respective first conversion branches of the two first main lines and in which the connection point is located between the first main line and the first conversion branch, and provides a same current reference value for the plurality of the first conversion branches of each of the first main lines according to a voltage loop output. Further, the voltage loop of the power conversion device is a DC side voltage during the charging process, and the voltage loop is an AC side voltage during the discharging process; wherein the DC side voltage is equal to a sum of that of the third capacitor and the fourth capacitor; the AC side voltage is equal to a sum of that of the first capacitor and the second capacitor.

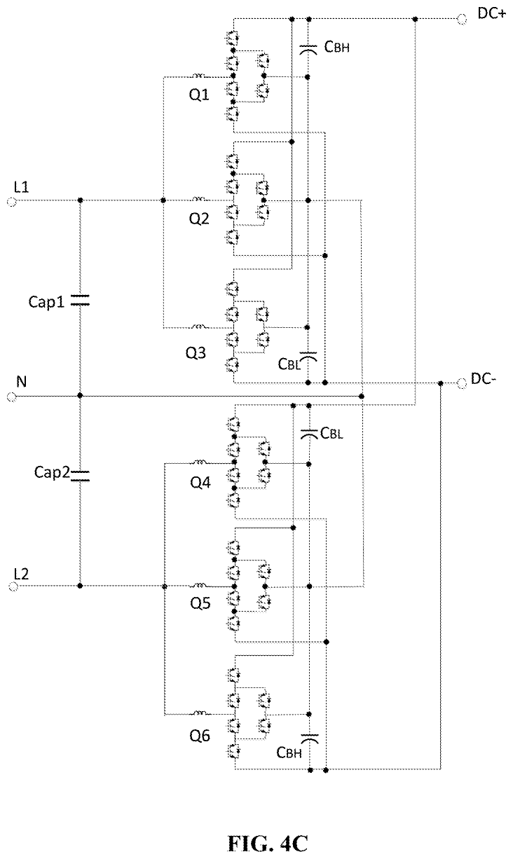

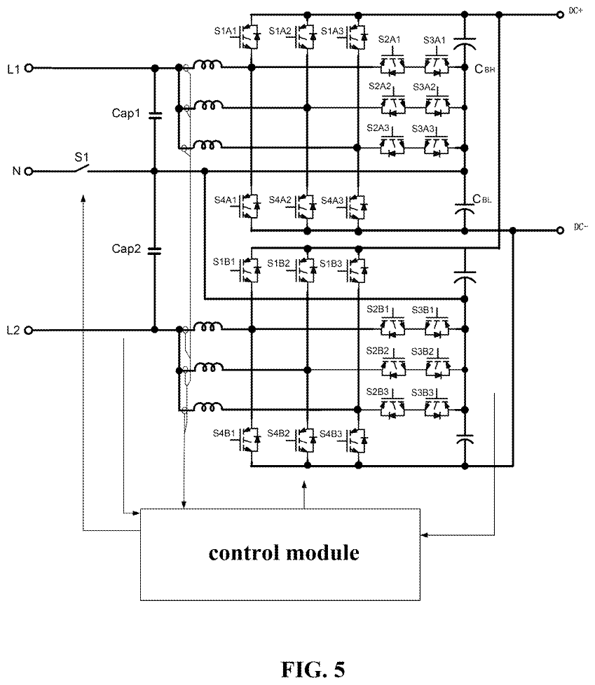

Specifically, as shown in FIG. 5, the control module may switch on an off the controllable switch S1 according to the received control parameters or other control signals. In order to ensure that the currents of the three interleaved lines are equal, the control module is respectively connected to each first conversion branch to provide a current reference value for the first conversion branch, wherein the same current reference value is used for the inductance control of the three first conversion branches in the L1 branch, to achieve the goal of current equalizing through closed-loop regulation. The L2 applies similar control method, the inductor current reference value is generated from the output of the voltage loop. The control block diagram is shown in FIG. 6. The control module outputs a uniform current reference value, compares the sampled current of each first conversion branch with the inductor current reference value to determine an inductor current adjustment parameter, and determines the duty cycle of each first conversion branch according to the comparison result of the grid voltage feedforward and the inductor current regulation parameter; wherein the grid voltage feedback is determined by a first capacitance, a second capacitance, a third capacitance, and a fourth capacitance. For example, in the charging mode, the voltage loop is a closed loop of DC side voltage (the sum of CBH and CBL voltages) sampling and target voltage, and in the discharging mode, the voltage loop is a closed loop of AC side voltage (CAP1, CAP2 voltages) sampling and the target voltage.

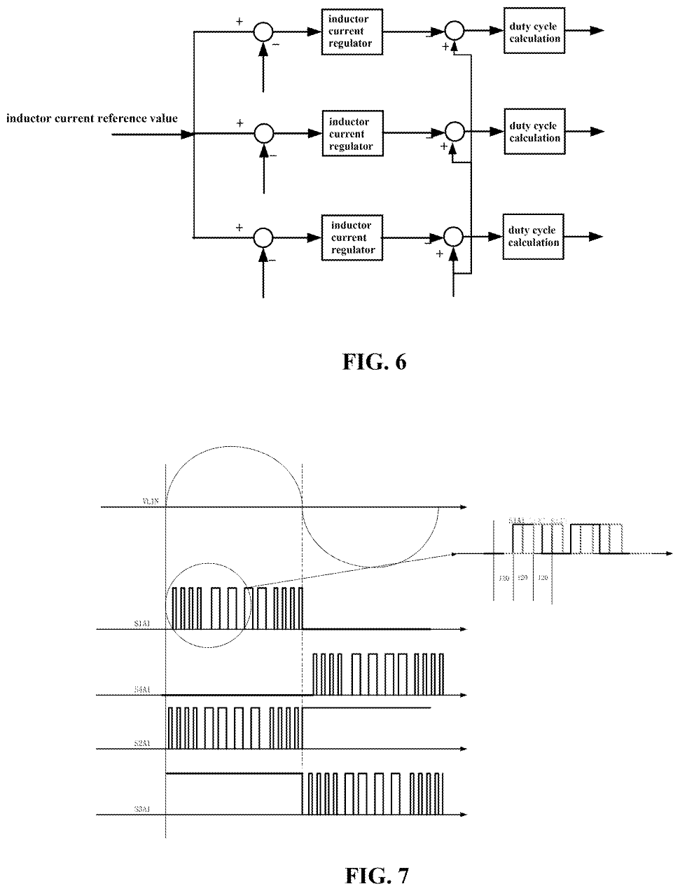

In an embodiment of the present application, the degree difference between the inverter of each of the first conversion branch and the second conversion branch is 360/N in a high-frequency operating state, where N is a positive integer. Further, in the low frequency operating state, the driving levels are the same. Specifically, as shown in FIG. 3 and FIG. 7, the control logic of the power conversion device is as follows: S1Ai (i=1,2,3) is complementary to S2Ai, and S3Ai is complementary to S4Ai. In the positive half cycle of the rectification mode, S1Ai is a continuous-flow tube, S2Ai is a main tube, S4Ai is the low level, and S3 Ai is the high level. In the negative half cycle of the rectification mode, S3Ai is a main tube, S4Ai is a continuous-flow tube, S2Ai is the high level, and S1Ai is the low level. In the high-frequency operating mode, the driving pulses of S1A1, S1A2, and S1A3 differ by 120 degrees from each other, and in the low-frequency operating mode, the driving pulses of S1A1, S1A2, and S1A3 are all high or low.

With the power conversion device and the control method thereof provided by the application, the switching loss of the switching device is reduced, the conversion efficiency is higher, and the application of multi-channel inverter interleaving technology also reduces the ripple and the volume of the filter device, and effectively reduces the practical application cost.

It should also be noted that in this specification, relational terms such as first and second and the like are only used to distinguish one entity or operation from another entity or operation, and the existence of any such actual relationship or order between these entities or operations is not necessarily required or implied. Moreover, the term “comprise”, “include” or any other variant intends to cover the non-exclusive inclusions, so that a process, a method, a commodity or a device comprising a series of elements comprise not only those elements, but also other elements not explicitly listed, or further comprise inherent elements of such process, method, commodity or device. An element that is defined by the phrase “comprising a . . . ” does not exclude the presence of additional elements in the process, method, product, or equipment that comprises the element. The terms “upper”, “lower” and the like indicate an orientation or position relationship based on the orientation or position relationship shown in the drawings, merely for convenience of description and simplification of the present application, but do not indicate or imply that the device or element referred to must have a particular orientation, be constructed and operated in a specific orientation, and therefore should not be construed as limiting the present application. The terms “installed”, “connected to”, “connected” are to be understood in a broad sense unless expressly specified and defined otherwise. For example, the connection may be a fixed connection, a detachable connection or an integrated connection, or may be a mechanical connection or an electrical connection, or may be a direct connection, or may be an indirect connection through an intermediary, or an internal communication between two elements. The specific meanings of the above terms in the present application may be understood by those ordinarily skilled in the art as the case may be.

The various embodiments in the specification are described in a progressive manner, and the same or similar parts between the various embodiments may be referred to each other, and each embodiment focuses on the differences from the other embodiments. In the description, reference terms “one embodiment”, “some embodiments”, “example”, “specific example” or “some examples” are used to mean that specific features, structures, materials or characteristics described by combining the embodiment or example are included in at least one embodiment or example in the embodiments of the present specification. In the present specification, exemplary expression of the above terms does not necessarily refer to the same embodiment or example. Moreover, the described specific features, structures, materials or characteristics may be combined in a suitable manner in any one or more of the embodiments or examples. Furthermore, those skilled in the art can combine different embodiments or examples described in the present specification and features of the different embodiments or examples in the case that they are not contradictory to each other.

The present application adopts specific embodiments to explain the principle and implementation way of the present application. The above embodiments are described merely for helping to understand the method and core concept of the present application; in addition, a person skilled in the art can, on the basis of the concept of the present application, make modifications to both of the specific embodiments and application scope. In conclusion, contents disclosed herein should not be understood as limitation to the present application.

1. A three-level control circuit, characterized in that, the three-level control circuit includes two first main lines and two second main lines between a three-phase port and a two-phase terminal thereof;
the first main line includes a plurality of first conversion branches, the second main line includes two capacitor branches and a plurality of second conversion branches, and the first conversion branches and the second conversion branches are in interleaved connection by an inverter interleaving technology;
each of the capacitor branches has a third capacitor and a fourth capacitor connected in series, the plurality of the first conversion branches of each of the first main lines are respectively connected to correspond to the capacitor branch, and a connection point is located between the third capacitor and the fourth capacitor.

2. The three-level control circuit according to claim 1, characterized in that, the three-level control circuit further comprise a capacitor circuit, wherein the capacitor circuit comprises a first capacitor and a second capacitor;
the three-phase port includes a first AC port, a second AC port, and a third AC port;
the two-phase terminal includes a first DC terminal and a second DC terminal;
the first capacitor and the second capacitor are coupled between the first AC port and the third AC port, and there is an intermediate node between the first capacitor and the second capacitor, the second AC port is connected respectively to the capacitor branches through the intermediate node, and the connection point is located between the third capacitor and the fourth capacitor of each of the capacitor branches.

3. The three-level control circuit according to claim 2, characterized in that, inductors are connected in series between the first conversion branch and the first main line, one end of the plurality of the first conversion branches is connected in parallel into the first main line through an inductor; the plurality of the second conversion branches and the capacitor branch are connected in parallel between the first DC terminal and the second DC terminal; wherein the first conversion branch and the second conversion branch correspond to each other one by one.

4. The three-level control circuit according to claim 1, characterized in that, the three-level control circuit is a T-type three-level control circuit or a PFC three-level control circuit or an I-type three-level control circuit.

5. The three-level control circuit according to claim 4, characterized in that, when the three-level control circuit is a T-type three-level control circuit, at least two controllable semiconductor devices are connected in series on each of the first conversion branches, at least two controllable semiconductor devices are connected in series on each of the second conversion branches; the first conversion branches and the second conversion branches correspond to each other one by one and intersect to form an intersection node, and the intersection node is located between the controllable semiconductor devices connected in series on the second conversion branch.

6. A power conversion device, characterized in comprising the three-level control circuit and a control module, wherein:
the three-level control circuit includes two first main lines and two second main lines between a three-phase port and a two-phase terminal thereof;
the first main line includes a plurality of first conversion branches, the second main line includes two capacitor branches and a plurality of second conversion branches, and the first conversion branches and the second conversion branches are in interleaved connection by an inverter interleaving technology;
each of the capacitor branches has a third capacitor and a fourth capacitor connected in series, the plurality of the first conversion branches of each of the first main lines are respectively connected to correspond to the capacitor branch, and a connection point is located between the third capacitor and the fourth capacitor;
wherein one end of the control module is connected to the respective first conversion branch of each of the two first main lines, and the connection point is located between the first main line and the first conversion branch; and the other end of the control module is connected to the first capacitor, the second capacitor, the third capacitor, and the fourth capacitor.

7. A control method applied to the power conversion device according to claim 6, characterized in that, the control module provides a same current reference value for the plurality of the first conversion branches of each of the first main lines according to a voltage loop output, and equalizes the currents of the first conversion branches through closed-loop regulation.

8. The control method according to claim 11, characterized in that, the voltage loop of the power conversion device is a DC side voltage during the charging process, and the voltage loop is an AC side voltage during the discharging process;
wherein the DC side voltage is equal to a sum of that of the third capacitor and the fourth capacitor; the AC side voltage is equal to a sum of that of the first capacitor and the second capacitor.

9. The control method according to claim 11, characterized in that, the degree difference between the inverter of each of the first conversion branch and the second conversion branch is 360/N in a high-frequency operating state, where N is the number of the first conversion branches on the first main line.

10. The control method according to claim 11, characterized in that, in the low-frequency operating state, the driving level of the inverters of each of the second conversion branches are the same.

11. The power conversion device, characterized in comprising the three-level control circuit and the control module according to claim 6, wherein:
the three-level control circuit further comprise a capacitor circuit, wherein the capacitor circuit comprises a first capacitor and a second capacitor;
the three-phase port includes a first AC port, a second AC port, and a third AC port;
the two-phase terminal includes a first DC terminal and a second DC terminal;
the first capacitor and the second capacitor are coupled between the first AC port and the third AC port, and there is an intermediate node between the first capacitor and the second capacitor, the second AC port is connected respectively to the capacitor branches through the intermediate node, and the connection point is located between the third capacitor and the fourth capacitor of each of the capacitor branches.

12. The power conversion device, characterized in comprising the three-level control circuit and the control module according to claim 7, wherein:
inductors are connected in series between the first conversion branch and the first main line, one end of the plurality of the first conversion branches is connected in parallel into the first main line through an inductor; the plurality of the second conversion branches and the capacitor branch are connected in parallel between the first DC terminal and the second DC terminal; wherein the first conversion branch and the second conversion branch correspond to each other one by one.

13. The power conversion device, characterized in comprising the three-level control circuit and the control module according to claim 6, wherein:
the three-level control circuit is a T-type three-level control circuit or a PFC three-level control circuit or an I-type three-level control circuit.

14. The power conversion device, characterized in comprising the three-level control circuit and the control module according to claim 9, wherein:
when the three-level control circuit is a T-type three-level control circuit, at least two controllable semiconductor devices are connected in series on each of the first conversion branches, at least two controllable semiconductor devices are connected in series on each of the second conversion branches; the first conversion branches and the second conversion branches correspond to each other one by one and intersect to form an intersection node, and the intersection node is located between the controllable semiconductor devices connected in series on the second conversion branch.
